(19) United States
(12) Patent Application Publication
(10) Pub. No.: US 2002/0057202 A1
(43) Pub. Date: May 16, 2002

(54) Infant monitoring system

(75) Inventor: Ronen Luzon, Tel Aviv (IL)

Correspondence Address: BROWDY AND NEIMARK, P.L.L.C., 624 NINTH STREET, NW, SUITE 300, WASHINGTON, DC, 20001-5303, US

(73) Assignee: 2SPOT. COM LTD., Tortola (VG)

(21) Appl. No.: 09/983,767

(22) Filed: Oct. 25, 2001

Related U.S. Application Data
(63) Continuation-in-part of application No. 09/696,638, filed on Oct. 26, 2000.

(51) Int. Cl. G08B 23/00

(52) U.S. Cl. 340/573.1; 340/604

(57) ABSTRACT

An infant monitoring system providing a communication link between an infant wearing a diaper sleeping in a crib and its mother at a remote station, the system alerting the mother in the event the baby in the crib has ceased to breathe or has a fever, or is awake and crying. The system includes a module attached to the diaper at a position engaging the belly of the baby and including three sensors. The first sensor responds to rhythmic belly movement accompanying breathing to produce a corresponding pulsatory signal that is interrupted only when the baby ceases to breathe. The second sensor is responsive to the temperature of the belly to yield a varying signal whose magnitude is high should the baby have a fever. The third sensor is responsive to sound to yield an audio signal, should the baby be awake and crying. These sensor signals are applied through a multiplexer to a microwave transmitter to modulate a microwave carrier. The remote station includes a receiver to intercept and demodulate the carrier radiated from the module transmitter and a multiplexer coupled to the receiver to recover the sensor signals and to apply these signals to distinctive alarms which serve to alert the mother should her infant cease to breathe or have a fever, or be crying whereby the mother can then take an appropriate action.

### RELATED APPLICATION

This application is a continuation-in-part of my co-pending application Ser. No. 09/696,638 entitled “SIDS MONITORING SYSTEM” filed Oct. 26, 2000. The entire disclosure of this co-pending application is incorporated herein by reference.

### BACKGROUND OF INVENTION

1. Field of the Invention

This invention relates generally to an infant monitoring system adapted to convey to a mother at a remote station vital information regarding the condition of her infant sleeping in a crib; and particularly to a system of this type in which the information is transmitted from a module attached to the diaper being worn by the infant, the module sensing whether the infant is breathing or has a fever, or is awake and crying.

2. Status of Prior Art

A typical household having young parents has an infant sleeping in a crib in a nursery and a mother who usually sleeps in a bedroom near the nursery or several rooms away. In either case, the mother of the infant, unless she visits the nursery to inspect her sleeping child, is not aware of its existing condition. Even if her baby in the crib is crying, a mother who is asleep in an adjoining bedroom may not be awakened by these sounds.

The condition of greatest concern to a mother is whether her infant in the crib has ceased breathing and therefore is at the onset of a sudden infant death syndrome (SIDS). SIDS refers to the death of an apparently healthy infant, usually less than one year old, the cause of which is unknown. It usually takes place in a crib while the baby is fast asleep and is therefore also called “crib death”.

Because the nature of SIDS remains a mystery and it is impossible for an infant's mother to anticipate whether her sleeping baby will suddenly be subject to this dreadfil condition, the resultant uncertainty is disturbing and worrisome. This is particularly the case should the infant be sleeping in a nursery while the parents are sleeping in a bedroom some rooms away from the nursery and therefore cannot observe the sleeping baby.

A typical mother when an infant is just a few months old, will as a matter of course wake up during the night to check on the condition of her baby sleeping in a crib. But a nocturnal inspection of a sleeping baby may be too late to avoid SIDS, for once the baby ceases to breathe, it may be only a matter of minutes before the baby is dead and cannot be resuscitated. The only hope of averting a SIDS disaster is for a parent to be immediately alerted to the fact that the infant has just stopped breathing, for then the parent can take emergency measures to revive the baby.

The prior art recognizes the problems involved in seeking to avoid SIDS and provides various systems to monitor a sleeping infant in order to alert a parent or other caretaker that the infant is showing initial signs of SIDS.

This PCT publication WO 9918843 discloses a device to alert a parent of a precursor sign of SIDS, this sign being an unexpected change in the temperature of a sleeping infant. To this end, the monitor includes a temperature transducer to sense any change in body temperature.

But while at the onset of SIDS there is a significant change in body temperature, say from 33° C. to 29° C. this change is not abrupt but gradual. Hence by the time the monitor senses this change, it may be too late to revive the infant.

The most dramatic sign of the onset of SIDS is the cessation of breathing, and unless immediate steps are then taken to resuscitate the infant, the infant will not survive. U.S. Pat. No. 5,825,293 discloses a SIDS monitoring system in which a magnet attached to a shirt worn by the infant senses movement of the chest during breathing. A detector mounted at the foot of the bed on which the infant is sleeping is responsive to magnetic field variations induced by the infant's chest movement during breathing. When the detector senses an abnormal breathing pattern it sounds an alarm.

This monitor is capable of alerting a parent of a SIDS condition only when the parent is in the same room as the infant, for the detector is mounted on the bed on which the infant is sleeping. The detector cannot be placed in another room, for it would then be well outside of the magnetic field emanating from the magnet.

U.S. Pat. No. 5,774,055 shows a box-like infant respiratory SIDS monitor that clips onto a diaper and includes a belly-motion sensor whose signal is coupled to a loud speaker within the box to sound an alarm should the baby cease to breathe. U.S. Pat. No. 5,400,012 shows a similar box-like SIDS monitor that includes an amplifier for the sensor signal. But as a practical matter, a SIDS alarm which is generated in the crib is of little value to a mother who is sleeping in another room.

Also of prior art interest is U.S. Pat. No. 5,774,055 which shows an infant monitoring system which includes a module that can be clipped onto a baby's diaper. This module functions to sense the orientation or position of the baby in the crib and to close a switch only when the position of the baby in the crib is objectionable. This positioning sensor is connected to a transmitter whose signal is picked up by a remote receiver. This receiver actuates an alarm only when the body assumes an objectionable position, causing the switch to close.

The only concern of U.S. Pat. No. 5,775,055 is with sensing the position of the baby in the crib and to alert the mother when the baby assumes a position that is objectionable. Thus the patent points out that frequent changes in the baby's position may indicate a fever or a dirty diaper, whereas an upright position may indicate that the child is awake and seeking to climb out of its crib. A supine position may increase the risk of the baby choking, whereas prolonged sleeping in the prone position may lead to an increased risk of sudden death syndrome (SIDS) associated with such a position.

In my above-identified co-pending patent application, a system is disclosed which links an infant sleeping in a crib and wearing a diaper with a portable monitoring station, the system acting to alert a parent attending the station that the infant in the crib has ceased to breathe, this being symptomatic of a sudden infant death syndrome (SIDS).

The SIDS system includes a module mounted on the diaper and responsive to rhythmic movement of the infant's belly which accompanies breathing to produce a pulsatory signal that is microwave transmitted to a receiver at a monitoring signal. The received signal is processed to determine whether it is interrupted for a predetermined brief period indicative of the cessation of breathing, in which event an alarm is sounded to alert the parent to the need to take immediate steps to resuscitate the infant.

A child asleep in a crib may in the course of sleeping undergo many changes in its condition, such as a change in position which makes the child uncomfortable and disturbs its sleep. Or in the course of sleep the child may throw off its covering blanket and then not be sufficiently warm to enjoy a sound sleep.

However there are only three conditions which may arise in the course of a baby's sleep in a crib, any one of which fully justifies awakening its mother sleeping in a nearby room to alert her to a condition requiring her immediate attention. These three conditions are the following:

Condition X (Breathing) In this emergency condition, the infant has ceased to breathe.

Condition Y (Fever) The body temperature of the baby has risen to an alarming degree, indicating a high fever.

Condition Z (Crying) Because the baby has become sick or for some other disturbing reason, the baby has awakened and is now crying loudly.

Condition X is extremely serious and it is of the utmost importance that it be detected without delay in so that the alerted mother can rush to the crib and resuscitate her child. Condition Y is also serious, for if the child has a high fever, then regardless of its origin, the mother, as soon as possible, must act to reduce it, for a high fever can have damaging consequences.

Condition Z, though not as serious as conditions X and Y, is not unimportant. If the infant who should be asleep in its crib has been awakened from sleep and is crying loudly, the cause of this condition may be minor. Or it may be major because the child has become ill and should be attended to without delay. In either case, whatever the reason for the child to awaken and bawl, it is necessary for the mother to take steps to calm her infant.

In medicine, it is the common practice to monitor a patient's primary condition by sensing his three “vital signs”. These signs are (a) pulse rate, (b) respiratory rate and (c) body temperature, for should any one of these signs be well-below par, it may then be necessary to take immediate action.

A system in accordance with the invention concurrently monitors only conditions X, Y and Z, these being the vital signs indicative of the basic status of the infant in the crib. The system functions, in effect, as a “baby phone,” by which the infant communicates with its mother to inform her why all is not well in the crib.

### SUMMARY OF THE INVENTION

In view of the foregoing, the main object of this invention is to provide an infant monitoring system functioning as a communication link between an infant lying in a crib and its mother at a remote monitoring station, the system serving to alert the mother to any one of three vital conditions that require her immediate attention.

More particularly, an object of this invention is to provide a system of the above type adapted to sense the vital signs of an infant's presence in the crib; namely Condition X in which the infant has ceased to breathe, Condition Y in which the infant has a fever and Condition Z in which the infant is crying loudly.

In the context of the present invention, a monitoring station is remote when its distance from the crib in which the infant is lying is such that should the infant cry out, the cry would not easily be heard at the station. Hence the station could be anywhere in a residence, other than the nursery.

A significant advantage of a system, in accordance with the invention, is that it will not disturb a mother who is sleeping in a bedroom, or is engaged in some other activity in her home unless a vital sign of the infant's presence is communicated to her by the system which justifies this disturbance and requires her to act quickly. Another advantage of the system is that it sends out no false alarms.

Also an object of this invention is to provide a monitoring system in which conditions X, Y and Z are sensed by a module mounted on the waist of the diaper worn by the infant in the crib, one sensor detecting breathing activity, a second detecting a body fever and the third a bawling infant.

Yet another object of the invention is to provide in a system of the above type a monitoring station that is portable and therefore can be placed at any site at which it can intercept a microwave signal radiated from the module.

Briefly stated, the objects are attained in a an infant monitoring system providing a communication link between an infant wearing a diaper sleeping in a crib and its mother at a remote station, the system alerting the mother only in the event the baby in the crib has ceased to breathe or has a fever, or is awake and crying. The system includes a module attached to the diaper at a position engaging the belly of the baby and including three sensors.

The first sensor responds to rhythmic belly movement accompanying breathing to produce a corresponding pulsatory signal that is interrupted only when the baby ceases to breathe. The second sensor is responsive to the surface temperature of the belly to yield a varying signal whose magnitude is high should the baby have a fever. The third sensor is responsive to sounds to yield an audio signal should the baby be awake and crying. These sensor signals are applied through a multiplexer to modulate the carrier of a microwave transmitter.

The remote station includes a receiver to intercept and demodulate the microwave carrier radiated from the module transmitter and a multiplexer coupled to the receiver to recover the sensor signals and to apply these signals to distinctive alarms which serve to alert the mother should her infant cease to breathe or have a fever, or be crying, whereby the mother can then take an appropriate action.

### BRIEF DESCRIPTION OF THE DRAWINGS

For a better understanding of the invention as well as other objects and features thereof, reference is made to the annexed drawings wherein:

FIG. 1 illustrates the module included in an infant monitoring system in accordance with the invention, the module being attached to a diaper worn by an infant sleeping in a crib and serving to microwave-transmit to a remote monitoring station signals indicative of three infant conditions representing infant vital signs.

FIG. 2 is a perspective view of the module;

FIG. 3 is a block diagram of the main components of the module;

FIG. 4 is a perspective view of the portable monitoring station included in the system; and

FIG. 5 is a block diagram of the remote station.

### DETAILED DESCRIPTION OF THE INVENTION

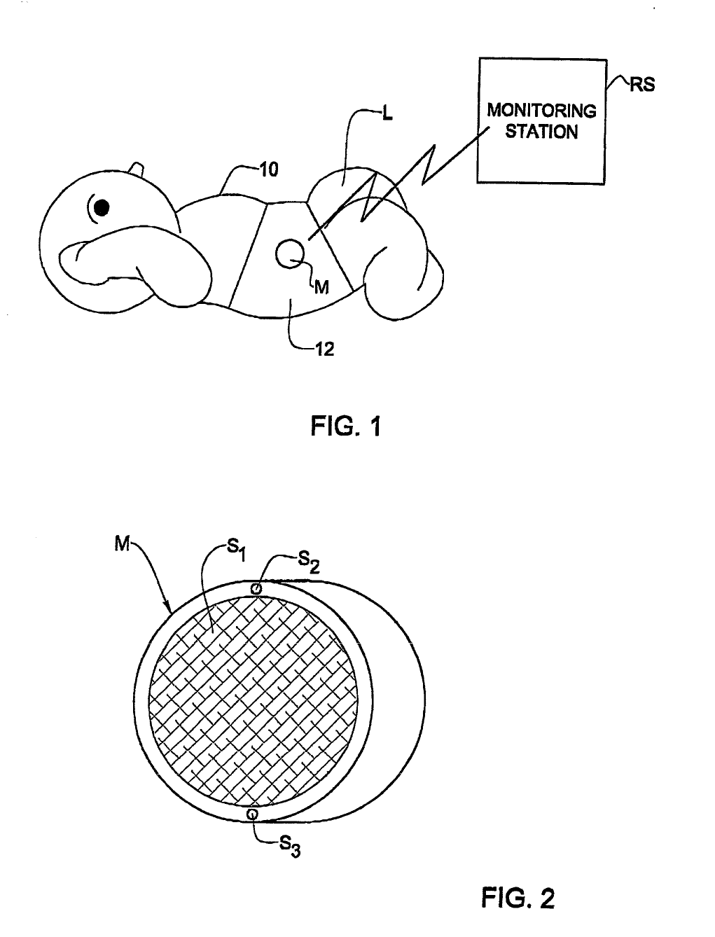

A monitoring system in accordance with the invention serves to monitor the vital signs of the presence of an infant 10 who as shown in FIG. 1 is sleeping in a crib 11, in a bed or in another suitable accommodation. Thus instead of the infant being put to sleep in a nursery crib, a baby carriage may be used for this purpose.

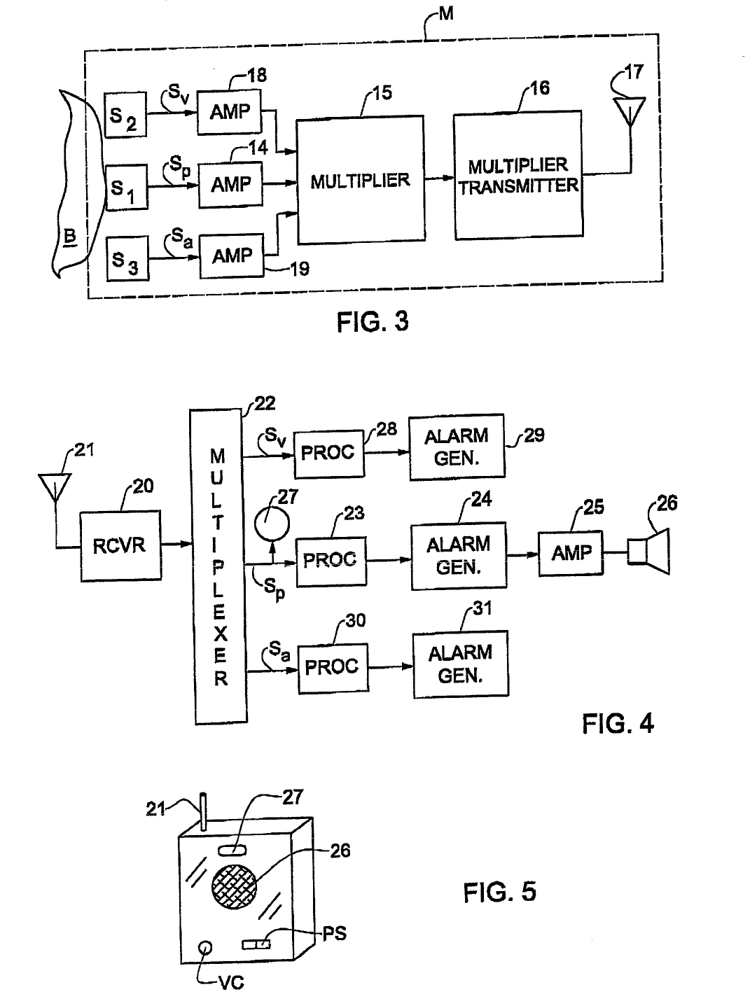

The system shown in FIGS. 1, 2 and 3 includes a module M mounted on a diaper 12 worn by the infant, the module being provided with a sensor responsive to rhythmic movement of the infant's belly accompanying breathing. This sensor yields a pulsating signal that is microwave-transmitted to a receiver at a monitoring station. The received signal is processed to determine whether it is interrupted for a predetermined brief period indicative of the cessation of breathing, in which event a distinctive alarm is sounded to alert the parent to take immmediate steps to resuscitate the infant.

The module also includes a sensor responsive to the temperature of the baby's body which when high (above 100° F.) is indicative of a high fever. And it has a sensor responsive to sounds produced by he baby when awake and crying. Hence module M is provided with three sensors S1, S2, and S3, sensor S1 detecting breathing activity, sensor S2 detecting body temperature, and sensor S3 detecting crying sounds at a bawling level.

The system is not limited to a crib environment and can operate regardless of where the infant is lying or sleeping. In that module M which senses the three vital signs of the infant's status is mounted on a diaper 12 being worn by the infant, wherever it may be, the module transmitting these signs to a remote monitoring station attended by a parent or caretaker of the infant.

A standard diaper 12 is a basic garment for an infant consisting of a folded cloth or other piece of absorbent material drawn up between the legs L of infant 10 and fastened about its waist. The traditional diaper is fabricated of woven cloth and is washable and therefore reusable. But in more widespread current use are disposable diapers formed of non-woven absorbent material capable of being used only once, after which it must be discarded.

When diaper 12 is worn by infant 10 sleeping in a crib 11, the waist section of the diaper then firmly embraces the belly B of the infant. Module M is so mounted in the waist section of the diaper that it is pressed against the belly of the infant. As illustrated in FIG. 2, module 12 is wafer shaped and has the diameter and thickness of a large coin. However in practice, module M may have a curved formation contoured to the belly of the infant.

Housed within the molded plastic casing 13 of module M, is sensor S1 which is a pressure-sensing transducer, preferably a piezoelectric element which when subjected to pressure generates a voltage whose magnitude is a function of the applied pressure. Transducer S1 is responsive to the varying pressures resulting from an in-and-out rhythmic movement of the infant's belly which accompanies breathing, this transducer therefore yielding a pulsatory signal indicative of this activity.

When breathing, the infant draws air into his lungs and then expels the air, the belly of the infant moving in and out in synchronism with the breathing activity. The belly movement is pronounced and the resultant pulsatory electrical signal Sp yielded by sensor S1 is indicative of the infant's breathing activity and of any interruption thereof. Pulsatory signal Sp is applied to an amplifier 14 whose amplified output is fed to one input channel of a multiplexer 15 whose output is fed to a microwave transmitter 16 whose carrier is modulated by the signal. The transmitter is connected to an antenna 17 which radiates the modulated microwave carrier.

Sensor S2 detects the surface temperature of the infant's belly which depends on the internal body temperature. It takes the form of a thermistor or other transducer yielding a signal Sv. The magnitude of signal Sv varies as a function of temperature. Signal Sv is fed through an amplifier 18 to a second input channel of multiplexer 15 to modulate the microwave carrier.

Sensor S3 detects crying sounds emanating from the infant and takes the form of a miniature microphone. This microphone is not pressed against the belly of the infant but is so placed in the module so as to pick up sounds heard in the vicinity of the belly. The resultant audio signal Sa is fed through an amplifier 19 to a third input channel of multiplexer 15 from which it is fed to the microwave transmitter.

The pulsatory signal Sp is in the low frequency audio range and the audio signal Sa is also in this range. In order to facilitate modulation of the microwave carrier, varying signal Sv which is not pulsatory is applied to a low-frequency oscillator which generates a signal in the audio range that is modulated by signal Sv. Thus radiated from antenna 17 is a microwave carrier modulated by signals yielded by sensors S1, S2 and S3.

Multiplexing is a well known technique which makes it possible to simultaneously transmit a plurality of different signals, signals on a common radio carrier without intermingling the signals. At the transmitting end of the system, the multiplexer acts to successively apply the signals to the radio carrier at a high repetition rate. And at the receiving end a multiplexer acts to successively extract the signals at the same repetition rate from the demodulated carrier.

As shown in FIGS. 4 and 5, the remote monitoring station RS is a battery-powered self-contained unit similar in size, shape and weight to a small transistor radio and similarly portable. Hence the mother of a baby lying in a crib and having the module M attached to a body site can take station RS to wherever in her residence in which she elects to be, other than the nursery.

The operating range of the module is about the same as that of a wireless telephone and therefore the system is not useable beyond the region of the home. Nor is it intended to be so useable, for the mother when alerted by an alarm, from the station must be then able to quickly reach her infant in the crib.

A receiver 20 in monitoring station RS connected to an antenna 21 intercepts the microwave carrier modulated by sensor signals S1, S2 and S3 radiated from module M and demodulates the carrier to recover these signals. These are applied to a multiplexer 22 having three output channels which respectively yield signals Sp, Sv and Sa.

Pulsatory signal Sp which represents breathing activity is fed by multiplexer 22 to a processor 23 which may be constituted by a microprocessor chip, which functions to analyze the pulsatory signal. This signal, when the infant is breathing, is continuous and the processor acts to determine whether the signal is at any time interrupted and in the event of an interruption, to time its duration. Processor 23 is arranged to measure the duration of the interruption and should the interruption last for more than a predetermined brief interval (i.e., 2.5 seconds), the processor in that event will then activate an alarm-signal generator 24.

Instead of a microprocessor, use may be made of an electronic timer whose timing is initiated by a pulse in the pulsatory signal P applied thereto, and is reset by a subsequent pulse. But if the signal is interrupted and there is no subsequent pulse, then when the timed interval following the initiating pulse reaches 2.5 seconds, the timer then activates the alarm.

Alarm-signal generator 24 is preferably an audio frequency oscillator which is modulated to produce, when amplified in amplifier 25 and reproduced in the loud speaker 26, a siren-like sound. This alarming sound, which is indicative of an emergency will alert a parent or caretaker that the infant in the crib has ceased to breathe, possibly because of SIDS, and there is now an urgent need to rush to the crib to resuscitate the infant.

Pulsatory signal Sp is also applied to a light-emitting diode (LED) pilot light 27 which is mounted on the face of the monitoring unit as shown in FIGS. 4 and 5. When the infant is breathing, the resultant pulsating signal Sp causes the LED to emit a pulsating green light. Hence when the RS unit is first switched on by a power switch Ps to put it in operation, and the parent sees a pulsating green light being emitted by LED 27, this informs the parent that the system is operative and that the infant in the crib is breathing. Should the infant cease to breathe, then the pilot light will turn off and an alarm will be sounded. The unit also includes a volume control VC,

Hence the system in connection with the sensor which detects breathing activity performs the following functions:

I. It continuously tells a parent that the infant in the crib is breathing, the pulsatory LED light rate being low when the infant is asleep and higher when the infant is awake.

II. When the infant in the crib stops breathing, it immediately alerts the parent that there is now a SIDS emergency.

When the system is to be used in conjunction with disposable diapers, module M which is inexpensive to mass-produce and is composed mainly of IC chips may be incorporated in the structure of the diaper waist section so that the module is M is discarded with the diaper after a single use. An appropriate term for a module integrated with a diaper is “smart diaper”.

In integrating a module with a diaper, then in the course of the diaper manufacturing procedure, the module is merged with the waist section of the diaper. But if the cost of the module is relatively high so as to rule out its disposal after a single use, then the rear face of the module casing should be coated with a pressure-sensitive adhesive layer so that the module can then be adhered to the waist section of a diaper. When this diaper has served its purpose and is taken off the infant, the module can be detached therefrom and applied to a fresh diaper.

Signal Sv from multiplexer 22 in station, RS is fed to a processor 28 adapted to evaluate the varying body temperatures represented by the signal and to activate an alarm generator 29 only when the temperature approaches an alarming level reflecting a high fever.

A baby in the course of sleep may undergo a rise in body temperature indicative of a low fever in which case it is best not to alert the mother and interrupt the baby's sleep, for continued sleep will usually bring about a return to a normal body temperature level. But the mother must be alerted if her baby's fever is high, for this is usually symptomatic of a serious malady and the need to take immediate steps toward reducing the high fever.

Alarm generator 29 whose output is fed to loud speaker 26 must create a distinctive sound that cannot be cored with the siren-like sound produced when the infant has ceased to breathe. Thus generator 29 may be arranged to produce periodic high-pitched pulses at a repetitive rate of say 120 pulses per minute.

Multiplexer 22 feeds signal Sa to a processor 30 which analyzes the various sounds emanating from the baby and activates an alarm generator 31 whose output is applied to loud speaker 26 only when the sounds of crying are loud, approaching the level of bawling. The reason for this limitation is that it is not uncommon for a baby in the course of sleep to emit whimpering sounds or to cry softly, in which case the mother should not be alerted and the child's sleep disturbed.

But should the child awaken and proceed to bawls then the child is in need of attention and the mother must be alerted. The sounds produced by alarm generator 31 must be different from those produced by the other alarm generators. Or one may omit alarm generator 31 and directly reproduce the bawling sounds of the baby which will certainly alert the mother to the need to attend her child.

In practice, module M need not be attached to the infant's diaper but may be placed at whatever body site at which it is possible to detect a rhythmic movement that accompanies breathing. Thus module M may be sewn into a fabric band provided with a Velcro fastener so that the band can be looped about the chest of the baby, thereby causing the module to engage the chest to sense its movement and its temperature as well as sounds emanating from the baby to produce the signals representing the vital signs of the infant's presence in the crib. The module in this instance is made waterproof so that the fabric band can be washed and reused, rather than being discarded after a single use.

While there has been disclosed a preferred embodiment of an infant monitoring system in accordance with the invention, it is to be understood that many changes may be made therein without departing from the spirit of the invention. Thus instead of a microwave link, an infrared link between the module and the monitoring station may be employed. Also information as to the status of the infant supplied by the module to the monitoring station can be transmitted by a cellular phone link from the monitoring station to a cellular phone set being carried by the mother or other caretaker of the infant.

If therefore the mother is away from her bedroom, or whatever other site at which the monitoring station is placed, when the mother is shopping or engaged in some other activity, she will nevertheless be alerted to the vital signs of the infant presence in the crib.

1. A system adapted to link an infant who is wearing a diaper and is sleeping at a local site with a monitoring station located at an external site attended by a caretaker for the infant, said system functioning to alert the caretaker in the event the infant has ceased to breathe or has a fever or is crying; said system comprising:
A. a module mountable on the infant to engage a surface thereon which as the infant breathes moves rhythmically in and out, the surface being at a temperature that depends on the internal body temperature of the infant said module including:
(a) a first sensor responsive to movement of said surface to yield a corresponding pulsatory signal;
(b) a second sensor responsive to changes in said surface temperature to produce a signal which varies accordingly;
(c) a third sensor responsive to said crying sounds to produce a corresponding audio signal, and
(d) a microwave transmitter whose carrier is modulated by the first, second and third sensor signals whereby radiated from the module is the modulated microwave carrier; and
B. a monitoring station at said external site, said station including:
(a) means including a receiver which intercepts and demodulates the radiated carrier and acts to recover the pulsatory signal, the varying signal and the audio signal; and
(b) means responsive to the recovered signals to activate respective alarms and thereby alert the caretaker in the event of an interruption in the pulsatory signal indicating that the infant has ceased to breathe, or in the event the infant has a fever or cries.

2. A system as set forth in claim 1, in which the module is mounted in a diaper worn by the infant.

3. A system as set forth in claim 1, in which said diaper has a waist section that engages the belly, and the module is integrated with the waist section.

4. A system as set forth in claim 1, in which the diaper has a waist section and the module is coated with a layer of pressure-sensitive adhesive so that the module can be adhered to this section.

5. A system as set forth in claim 1, in which the module is attached to a band looped about the infant's chest.

6. A system as set forth in claim 1, in which the first sensor is a piezoelectric element.

7. A system as set forth in claim 1 in which the second sensor is a thermistor.

8. A system as set forth in claim 1, in which the third sensor is a microphone.

9. A system as set forth in claim 1, in which the means at the station which activates the alarm for the signal from the first sensor includes a microprocessor adapted to time the duration of the interruption of the signal and to activate the alarm when the duration of the interruption exceeds a predetermined brief interval.

10. A system as set forth in claim 8, in which the interval is about 2.5 seconds.

11. A system as set forth in claim 1, in which the alarm for the cessation of breathing includes an audio oscillator modulated to produce a siren-like sound.

12. A system as set forth in claim 1, in which the means at the station which activates the alarm for body temperature is adapted to activate this alarm only when the body temperature approaches a fever level.

13. A system as set forth in claim 1, in which the means at the station which, activates the alarm for crying sounds activates this alarm only when the crying of the infant is at a bawling level.

14. A system as set forth in claim 1, in which the sensor signals are applied through a multiplexer to said transmitter to prevent intermixing of the sensor signals modulating the carrier.

15. A system as set forth in claim 14, in which the demodulated carrier signals at the station are fed through a multiplexer to recover the sensor signals.

16. A system adapted to link an infant wearing a diaper to a monitoring station attended by a caretaker for the infant so as to alert the caretaker should the infant cease to breath, or has a fever, or is crying; said system comprising:
A. a module mountable on the diaper so as to engage a surface of the infant which moves in and out as the infant breathes and which rises in temperature when the infant has a fever, said module being exposed to sounds when the infant is crying;
B. a first sensor included in the module responsive to movement of the surface to provide a first signal indicative of breathing or an interruption thereof;
C. a second sensor included in the module responsive to the temperature of the surface to provide a second signal indicative of a fever;
D. a third sensor included in the module responsive to said sounds to provide a third signal indicative of crying, and
E. a transmitter included in the module to convey the first, second and third signals to said monitoring station.

17. A system as set forth in claim 16 in which said transmitter is a microwave transmitter whose carrier is modulated by said signals, and said monitoring station includes a microwave receiver to demodulate said carrier to recover said signals, and means associated with the receiver to alert the attendant when the signals indicate that the infant has ceased to breathe, or has a fever, or is crying.

18. A module attachable to a diaper worn by an infant to engage a surface of the infant which moves in and out as the infant breathes, which rises in temperature when the infant has a fever and is exposed to sounds when the infant is crying, said module comprising:
A. a first sensor responsive to movement of the surface to provide a first signal indicative of breathing or an interruption thereof;
B. a second sensor responsive to the temperature of the surface to provide a second signal indicative of a fever;
C. a third sensor responsive to said sounds to provide a third signal indicative of crying; and
D. a transmitter to transmit the first, second and third signals to a monitoring station.
